(19) United States
(12) Patent Application Publication
(10) Pub. No.: US 2011/0266825 A1
(43) Pub. Date: Nov. 3, 2011

(54) Attachable Vehicle Sun Visor for Improved Sun Blockage

(76) Inventor: Eugenio F. Bagioli, Fresno, CA (US)

(21) Appl. No.: 12/769,625

(22) Filed: Apr. 28, 2010

(51) Int. Cl. B60J 3/02

(52) U.S. Cl. 296/97.6

(57) ABSTRACT

A vehicle sun visor that attaches to a vehicle's existing sun visor to more effectively block the sun so it will be less likely to interfere with the driver or bother the eyes of the driver or passenger. The attachable sun visor comprises a first section that securely attaches to the existing sun visor, a second section that slides and pivots outward relative to the first section and a third section that slides downward relative to the second section to block the sun when it is in a variety of different positions relative to the driver or passenger. Preferably, the first section removably attaches to the existing sun visor using a pair of straps connected by a hook and loop connector. A moving mechanism allows the second section to slide in two directions and pivot relative to the first section. A slide mechanism controllably slides the third section into position.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The present invention relates generally to sun visors and related devices that are utilized in vehicles to block the sun from the eyes of the driver and/or passenger while the vehicle is moving. In particular, the present invention relates to devices which attach to an existing vehicle sun visor to more effectively block the sun from the eyes. Even more particularly, the present invention relates to such devices that allow the user to effectively extend the width and height of the existing sun visor.

B. Background

As well known, one of the potential problems for a person who drives a car, truck, recreational vehicle or other motor vehicle is that the sun will be in his or her eyes while he or she is trying to see the road ahead. If the sun is in the driver's eyes at a critical time, such as when his or her vehicle is crossing paths with another vehicle, bicyclist, pedestrian or animal, the driver may not be able to see well enough to take the necessary evasive action. This can result in damage to the driver's vehicle, damage to another person's property and/or serious injury or even death to one or more occupants of the vehicle or to others. Even when the timing is not so critical, it is well known that drivers having to drive a vehicle while the sun is in their eyes is detrimental to the safe operation of the vehicle and uncomfortable to his or her eyes. Driving into the sun, such as when the sun is in the vehicle's forward direction of travel, or with the sun at the side of the vehicle, is a well known discomfort to the driver and/or a passenger in the vehicle. The changing position of the sun relative to the driver and passenger, due to the movement of the sun and vehicle, prevents having a permanent fix to the problem of the sun being in the eyes.

Sun visors have been utilized with cars, trucks and other vehicles for many years to block the sun from the eyes of the driver and/or the front seat passenger in a vehicle. A typical sun visor is comprised of a solid, rectangularly shaped material that is pivotally mounted to the window frame. When not in use, the prior art sun visor is pivoted generally upward against or near the interior of the vehicle roof so as to not block the vision of the driver or passenger. When needed to block the sun in front of the driver or passenger, the sun visor is folded downward in an attempt to provide a physical barrier between the eyes of the driver/passenger and the sun so he or she is not staring into the sun. Most prior art sun visors are also configured to allow the driver or passenger to pivot the sun visor from a position where it blocks the sun out the front windshield to a position where it is intended to block the sun through a side window. Unfortunately, prior art sun visors are frequently not fully effective at blocking the sun.

One feature of prior art sun visors that prevents them from fully being able to block the sun is that they are generally configured to be somewhat small relative to the vision of the driver or passenger out the front windshield or the size of their respective side windows. While this is good for being able to see out of the vehicle, particularly when the sun visor is not needed, this requirement does somewhat limit the effectiveness of the sun visor when needed to block the sun. Certain makes of vehicles have sun visors that have a portion which extends into and out of the sun visor to increase the effective length or width of the sun visor to better block the sun when it is positioned outside the relatively small area that is protected by the sun visor. Most vehicles, however, do not have sun visors that extend outward or downward, thereby limiting the protection of the sun visor to its small area. Replacing an existing sun visor with a new sun visor that has an extendable width or length, assuming that the vehicle has such an option or an after-market product is available, is generally not done by the vehicle owner or operator due to the cost and effort required. As such, despite the driving risks and the discomfort to the eyes, most people merely suffer through the well known limitations of the existing, prior art sun visors.

What is needed, therefore, is an improved sun visor apparatus that allows the owner or operator of a vehicle to quickly, easily and in a cost effective manner upgrade their existing sun visors to sun visors that extend outward and downward to more effectively block the sun from the eyes of the driver and/or the passenger. The desired sun visor apparatus should be configured to attach to and move with an existing sun visor in a vehicle and allow the user to extend the effective length and/or height of the sun visor. Preferably, such a sun visor apparatus will removably attach to the existing sun visor. The desired sun visor apparatus should be configured not to interfere with the driver's vision when not in use and to not interfere with the normal operation of the existing sun visor. The preferred sun visor apparatus should be easy to install, relatively inexpensive to manufacture and available for use to retrofit existing vehicles and in new vehicles as an original stock item.

### SUMMARY OF THE INVENTION

The attachable vehicle sun visor for improved sun blockage of the present invention provides the benefits and solves the problems identified above. That is to say, the present invention discloses an attachable sun visor that more effectively blocks the sun from the eyes of the driver or passenger while a vehicle is moving. The attachable sun visor of the present invention removably attaches to an existing sun visor to allow the user to extend the effective length and width thereof so the user may block the sun when it is in different positions relative to the user of the present invention. In the preferred embodiment, the attachable sun visor of the present invention does not interfere with the normal operation of the existing sun visor and, as desired by the user, moves with the existing sun visor to be in position to block the sun from the user's eyes. As such, the attachable vehicle sun visor allows the owner or operator of a vehicle to quickly, easily and in a cost effective manner upgrade an existing sun visor.

In one embodiment of the present invention, the attachable vehicle sun visor comprises: a first section having an attachment mechanism associated therewith for removably attaching the first section to a surface of the prior art sun visor, a second section; a moving mechanism interconnecting the first section and the second section for pivotally and slidably moving the second section generally outward relative to the first section; a third section; and a slide mechanism interconnecting the second and third sections for sliding the third section downward relative to the second section. In a preferred embodiment, the attachment mechanism has one or more straps that are configured to secure the first section, and therefore the attachable vehicle sun visor, to the prior art sun visor and the straps have a connecting mechanism, such as a hook and loop material, that secures the straps around the prior art sun visor. In the preferred embodiment, the moving means comprises a hinge that is configured to pivot the second section relative to the first section, a first slide member that is configured to allow the second section to slide outward relative to the first section and a second slide member that is configured to allow the second section to slide outward relative to the hinge. The preferred slide mechanism comprises a pair of brace members on the second section that are sized and configured to slidably engage an edge of the third section. In the preferred embodiment the edges of the third section are serrated for step-wise movement of the third section. The preferred embodiment also includes a pull member that is attached to or integral with the third section to pull the third section down into the desired position.

Accordingly, the primary objective of the present invention is to provide an attachable vehicle sun visor that provides the benefits described above and solves the problems associated with presently available sun visors and sun visor attachments.

More specifically, it is a primary objective of the present invention to provide an attachable vehicle sun visor that removably attaches to an existing sun visor without substantially interfering with the movement thereof and to extend outward and/or downward to more effectively block the sun from the user's eyes.

It is also an important objective of the present invention to provide an attachable vehicle sun visor that has a first section which is removably secured to an existing sun visor, a second section which pivots and slides outward relative to the first section and a third section which slides downward relative to the second section to allow the user to adjust the attachable sun visor to a position that most blocks the sun from his or her eyes.

It is also an important objective of the present invention to provide an attachable vehicle sun visor that comprises a moving mechanism that slidably moves one section of the sun visor outward in two directions, generally linear and perpendicular, relative to the existing sun visor.

The above and other objectives of the present invention are explained in greater detail by reference to the attached figures and description of the preferred embodiment which follows. As set forth herein, the present invention resides in the novel features of form, construction, mode of operation and combination of parts presently described and understood by the claims.

### BRIEF DESCRIPTION OF THE DRAWINGS

In the drawings which illustrate the best modes presently contemplated for carrying out the present invention:

FIG. 1 is a front view of a driver side prior art sun visor shown attached to the window frame of a vehicle;

FIG. 2 is an exploded front view of an attachable vehicle sun visor configured according to a preferred embodiment of the present invention;

FIG. 3 is a front perspective view of the assembled attachable vehicle sun visor of FIG. 2 shown pivoted open;

FIG. 4 is a front view showing the attachable vehicle sun visor of FIG. 3 being attached to the prior art driver side sun visor of FIG. 1;

FIG. 5 is a front view of the attachable vehicle sun visor of FIG. 3 shown pivoted closed and attached to the prior art sun visor of FIG. 1 shown with the sun below the vehicle sun visor;

FIG. 6 is a front view of the vehicle sun visor of FIG. 5 shown with the third section slid down for increased height to block the sun from the driver's eyes;

FIG. 7 is a front view of the vehicle sun visor of FIG. 5 shown with the second section pivoted to block the sun positioned generally to the right side of the driver;

FIG. 8 is a front view of the vehicle sun visor of FIG. 7 shown with the third section slid down to block the sun after it has gone down relative to its position in FIG. 7;

FIG. 9 is a front view of the vehicle sun visor of FIG. 5 shown with the second section slid to the right to block the view of the sun coming from the driver's front right position;

FIG. 10 is a front view of the vehicle sun visor of FIG. 9 shown with the third section slid down for increased height to block the sun from the driver's eyes;

FIG. 11 is a back view of the prior art sun visor of FIG. 1 shown pivoted to the driver's left side window in an attempt to block the sun therefrom;

FIG. 12 is a back view of the second section of the vehicle sun visor of FIG. 3 shown attached to the prior art sun visor of FIG. 11 with the second section slid rearward to extend the effective length of the sun visor and block the sun in the gap between the prior art sun visor and driver side window frame;

FIG. 13 is a back view of the vehicle sun visor of FIG. 12 shown with the third section slid downward to block the sun as it has gone down relative to its position in FIG. 12;

FIG. 14 is a front view of the vehicle sun visor of FIG. 3 shown attached to the prior art passenger side sun visor with the sun below the bottom edge of the combined sun visors;

FIG. 15 is a front view of the vehicle sun visor of FIG. 14 shown with the third section slid downward to increase the effective height of the sun visor to more effectively block the sun;

FIG. 16 is a front view of the vehicle sun visor of FIG. 15 shown with the second section slid to the left to increase the effective width of the sun visor to block the sun;

FIG. 17 is a front view of an attachable vehicle sun visor having a moving mechanism configured according to a preferred embodiment of the present invention shown with the second section pivoted outward;

FIG. 18 is a front view of the slide bar and slider of the moving mechanism utilized with the attachable vehicle sun visor of FIG. 17; and

FIG. 19 is an end view of the slider of FIG. 18.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the description and figures provided herein are directed to a particular configuration of a prior art sun visor and corresponding vehicle configuration, those skilled in the art will readily understand that this is set forth merely for purposes of simplifying the disclosure of the invention and that the present invention is not so limited.

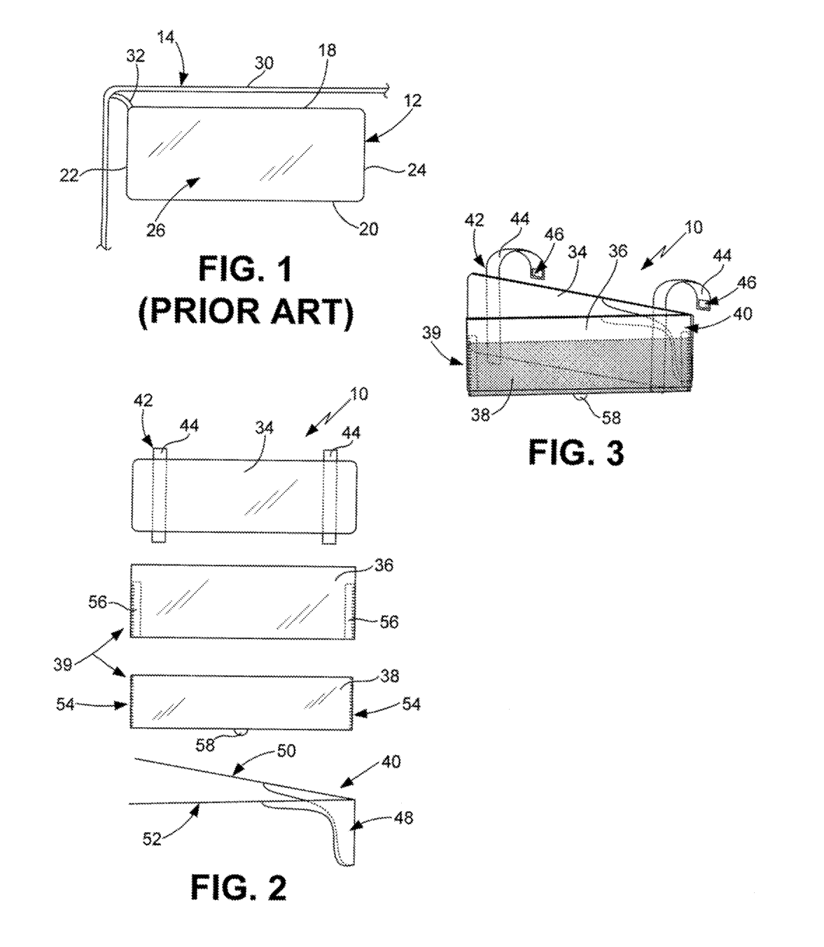

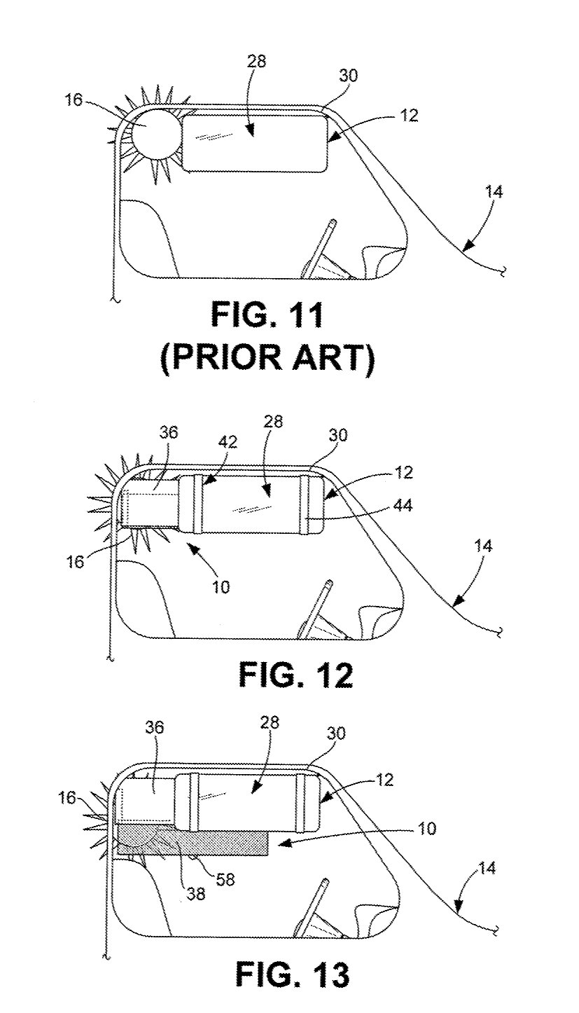

An attachable vehicle sun visor that is configured pursuant to a preferred embodiment of the present invention is shown generally as 10 in FIGS. 2 through 16. As set forth below, the attachable vehicle sun visor 10 removably attaches to a prior art sun visor, shown as 12 in FIG. 1, in a vehicle 14 to more effectively block the sun 16 from the user's eyes. The vehicle sun visor 10 better blocks the sun from the user's eyes by allowing the user to selectively increase the effective width and/or height of the prior art sun visor 12 as may be desired or necessary due to the position of the sun 16 relative to the user. The typical prior art sun visor 12 has a generally rectangular configuration with a top edge 18, bottom edge 20, left edge 22 and right edge 24 that define a front surface 26 and a back surface 28, as shown in FIGS. 1 and 11. In some vehicles 14, the prior art sun visor 12 has a generally oval or other configuration. As well known in the art, the typical prior art sun visor 12 is pivotally attached to the window frame 30 of vehicle 14 through use of an integral pivoting mechanism having visor arm 32 interconnecting the prior art sun visor 12 and window frame 30. The prior art sun visor 12 typically is pivoted upward against or near the interior roof of the vehicle 14 when not needed to block the sun 16 and, with regard to the driver, prevent the sun 16 from interfering with his or her driving. The pivoting mechanism of the prior art sun visor 12 is configured to allow the user to pivot prior art sun visor 12 downward to a substantially vertical position (as shown in FIG. 1), tilt generally forward and upward toward the windshield of vehicle 14 and pivot towards the side window (as shown in FIG. 11) to block the sun 16 from hitting the user's eyes as the vehicle 14 moves. As set forth in more detail below, the attached vehicle sun visor 10 of the present invention attaches to and moves with the prior art sun visor 12 to provide more effective blocking of the sun 16. However, the attached vehicle sun visor 10 is sized and configured so as to not interfere with the normal movement and operation of the prior art sun visor 12.

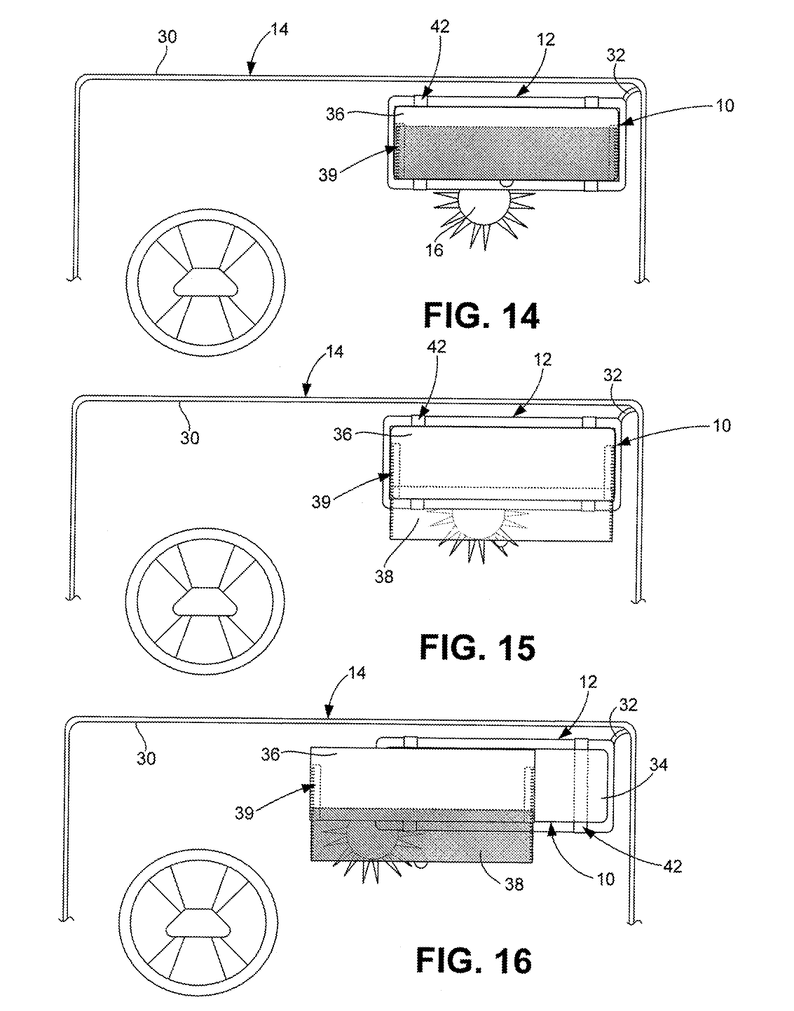

As shown in FIG. 1, the top 18 and bottom 20 edges of the prior art sun visor 12 define a height for the sun visor 12 and the left 22 and right 24 edges define its width. For the typical prior art sun visor 12, the height and width thereof are fixed. As set forth above, some vehicles 14 have a prior art sun visor 12 with a right extension portion that extends the length to the right and/or a lower extension portion that extends the height of the sun visor 12 to allow the user some flexibility with regard to blocking the sun 16. These types of prior art sun visors 12 are generally not widely available. The present invention allows the user of the attachable vehicle sun visor 10 of the present invention to obtain the benefits of these advanced prior art sun visors 12 without the need to replace the sun visor 12 and, as set forth below, provide additional benefits for the driver of vehicle 14 and, if desired, his or her passenger (as shown with regard to FIGS. 14 through 16).

In the preferred embodiment of the present invention, the attachable vehicle sun visor 10 generally comprises a first section 34, a second section 36 slidably and pivotally connected to the first section 34, a third section 38 slidably connected to the second section 36 by use of a sliding mechanism 39, a moving mechanism 40 that allows the second section 36 to slide and pivot relative to the first section 34 and an attachment mechanism 42 that attaches the first section 34, and therefore the entire attachable vehicle sun visor 10, to the prior art sun visor 12. In a preferred embodiment, the first 34, second 36 and third 38 sections each have a generally rectangular shape and are sized smaller than the dimensions of the prior art sun visor 12 such that when the attachable vehicle sun visor 10 is attached to the prior art sun visor 12 and in its retracted position it does not entirely cover the prior art sun visor 12, as best shown in FIG. 5. In the preferred embodiment, the first 34, second 36 and third 38 sections are made out of plastic or other easily moldable material. Alternatively, these components made be manufactured in different shapes, generally to correspond to the shape of the prior art sun visor 12, and out of a wide variety of materials. Preferably, the materials are generally lightweight so as to not interfere with the operation of the prior art sun visor 12 and made out of materials suitable for use in a vehicle 14 and exposure to the sun 16. In one embodiment, at least the third section 38 can be manufactured out of a generally transparent but UV reflective material, such as is utilized in sunglasses and the like, to allow the user to safely see through the third section 38 when it is in its lowered position.

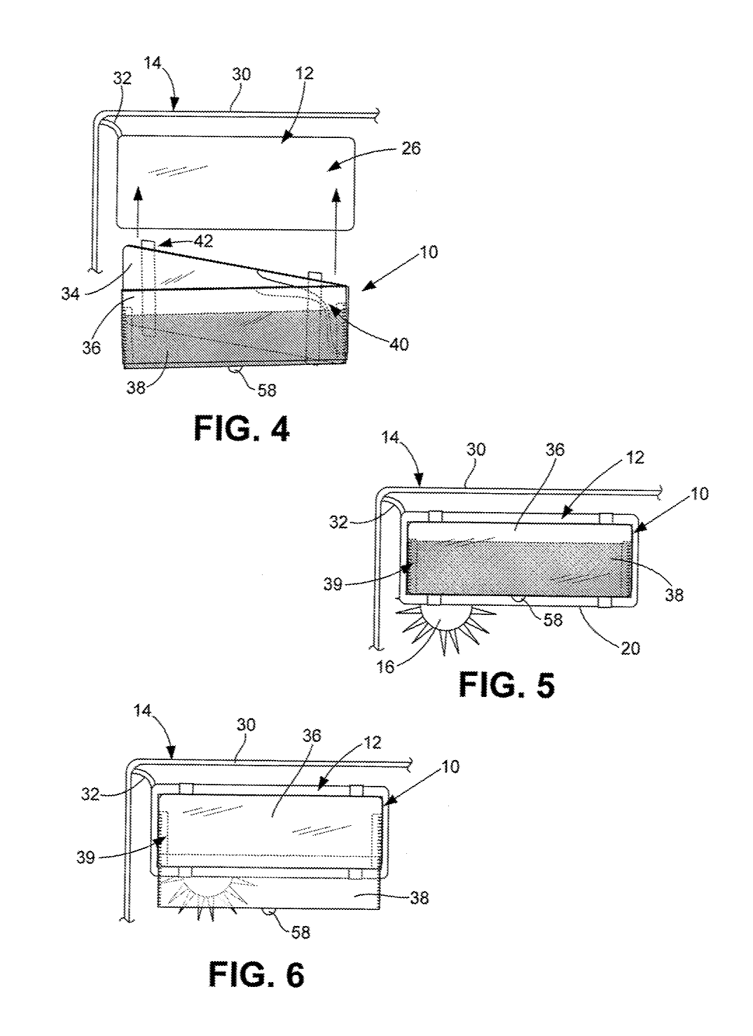

As stated above, the attachment mechanism 42 attaches the first section 34 and the entire attachable vehicle sun visor 10 to the prior art sun visor 12, preferably to the front surface 26 thereof. The attachment mechanism 42 is configured to securely and removably attach the attachable vehicle sun visor 10 to the prior art sun visor 12, as shown being directed onto the prior art sun visor 12 in FIG. 4. In the preferred embodiment, attachment mechanism 42 comprises one or more elongated straps 44 that go around prior art sun visor 12 to connect at the back surface 28 thereof and an appropriate connecting mechanism 46 to join the straps 44 together, as best shown in FIG. 3. In the embodiment shown in the figures, a pair of straps 44 are utilized to attach the attachable vehicle sun visor 10 to prior art sun visor 12. In the preferred embodiment, the connecting mechanism 46 for straps 44 is conventional hook and loop material (i.e., Velcro®) which is appropriately positioned on the straps 44 to connect straps 44 together. As will be readily apparent to persons skilled in the art, a variety of connecting mechanisms 46 can be utilized with attachment mechanism 42 to join straps 44 together. For instance, connecting mechanism 46 can comprise one or more snaps, buckles, ties, buttons or other fasteners. In an alternative embodiment, the attachment mechanism 42 can comprise straps 44 that are made out of appropriately sized elastic bands which go around the prior art sun visor 12 to securely hold the first section 34 of the attachable vehicle sun visor 10 to the prior art sun visor 12. As will be readily apparent, a variety of different attachment mechanisms 42 can also be utilized to removably attach the attachable vehicle sun visor 10 to the prior art sun visor 12.

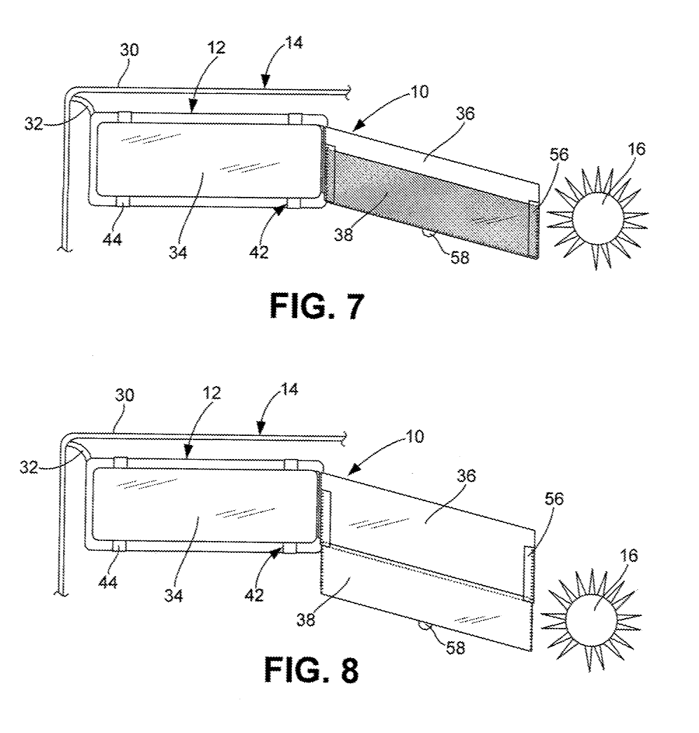

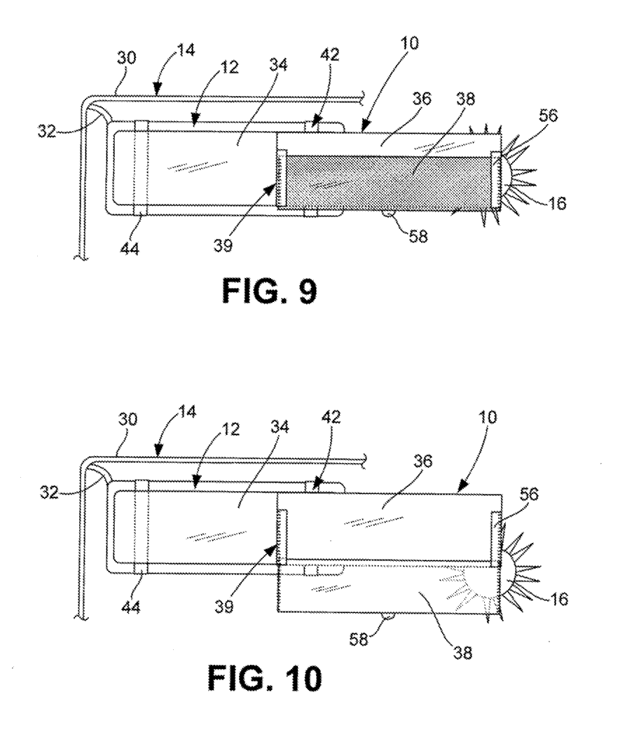

The moving mechanism 40 of the attachable vehicle sun visor 10 of the present invention is configured to allow the user to pivot the second section 36 relative to the first section 34 (typically rearward or away from prior art sun visor 12 and the windshield), slide the second section 36 outward relative to the first section 34 and the right edge 24 of the prior art sun visor 12 to extend the effective length of prior art sun visor 12 and slide the second section 36 outward away from the first section 34, as explained in more detail below and shown in FIGS. 7 through 10. In the preferred embodiment, the moving mechanism 40 comprises a hinge 48 that pivots second section 36 relative to first section 34, a first slide member 50 that slidably interconnects the second section 36 and the first section 34 and a second slide member 52 that slidably interconnects the second section 36 to the hinge 48. FIGS. 7 and 8 show the second section 36 pivoted outward away from the first section 34 to block the sun 16 from the driver when the sun 16 is positioned generally on the driver's right side (i.e., the sun 16 is shining on the driver through the windshield generally on the passenger's side or through the passenger side window). The hinge 48 should be configured to allow the driver to pivot the second section 36 outward and to hold the second section 34 in the desired position at an angle relative to the first section 34 and the prior art sun visor 12. The first slide member 50 is configured to allow the second section 36 to slide outward relative to the first section 34, but in or parallel to the plane of the first section 34, effectively extending the length of the prior art sun visor 12 at the right edge 24 thereof, as shown in FIGS. 9 and 10. As shown, this movement is particularly useful when the sun 16 is positioned in front of the driver but to the right of directly in front of the driver so that the attachable vehicle sun visor 10 can block the sun 16 from the driver's eyes. The second slide member 52 is configured to allow the second section 36 to move away from the first section 34 in a direction that is generally perpendicular to a plane through or parallel to the first section 34. This movement is particularly beneficial when the sun 16 is to the driver's right side but more to toward the rear of the vehicle 14 relative to that shown in FIGS. 7 and 8. With moving mechanism 40, the driver can manipulate the second section 36 relative to the first section 34 and the prior art sun visor 12 to block the sun 16 when it is in a number of different front and side positions.

As stated above, the slide mechanism 39 is utilized to allow the driver to slide the third section 38 down relative to the second section 36 to block the sun 16 when it is lower on the horizon (i.e., typically early or late in the day) than when using the second section 34 alone, as shown in FIGS. 6, 8 and 10. In the preferred embodiment, the slide mechanism 39 comprises a serrated edge 54 along the two vertical sides of third section 38 and a cooperatively configured brace member 56 along the corresponding vertical sides of the second member 36, as best shown in FIG. 2. Although the slide mechanism 39 can fit snugly between the edges 54 and brace members 56 (i.e., without any serrations or the like), the serrated edge 54 is preferred because it allows the driver to slide the third section 38 in a step-wise or click-like manner that holds the third section 38 in position relative to the second section 36. FIG. 6 shows the third section 38 slid downward relative to second section 36, which is left in its non-pivoted position against first section 34, to block the sun 16 when it is low on the horizon. FIG. 8 shows the third section 38 slid downward relative to the second section 36 to block the sun 16 when it is on the driver's right side or the passenger side of the vehicle 14 and low on the horizon. FIG. 10 shows the third section 38 slid down relative to the second section 36 to block the sun 16 when it is in front of but to the right of the driver and low on the horizon.

In the preferred embodiment, the third section 38 has a pull member 58, such as the pull tab shown best shown in FIGS. 2 through 6. Pull member 58 should be sized and configured to be relatively easy for the driver to grab onto to pull down the third section 38 but not so large or extend so far below third section 38 so as to interfere with the driver's ability to see out the vehicle 14. Preferably, pull member 58 is a relatively short, stubby pull tab. Alternatively, pull member 58 can be a string, rod, loop, wire, handle or other member that is of sufficient size for the typical driver or other user to quickly and easy grasp when it is desired to pull the third member 38 downward to block the sun 16 when it is low on the horizon. The pull member 58 should be fixedly attached to or integral with the third section 38

The attachable vehicle sun visor 10 can also be utilized to block the sun 16 when the sun 16 is positioned to the driver's left side, as shown in FIGS. 11 through 13. Normally, as shown in FIG. 11, the prior art sun visor 12 can pivot on the visor arm 32 such that it is directed along the driver's side window on his or her left to block the sun 16. Unfortunately, prior art sun visors 12 do not block the sun 16 on the left when it is generally to the left and rearward on the driver's left side (i.e., in the gap between the right/rear edge 24 and the driver's door frame) and/or when the sun 16 is low on the horizon. The attachable vehicle sun visor 10 of the present invention solves this problem. As shown in FIG. 12, if the sun 16 is to the left and rearward, the driver only has to extend second section 36 outward from first section 34 a sufficient distance to block the sun 16. When the sun 16 is low on the horizon, such as shown in FIG. 13, the driver only has to extend the third section 38 downward from the second section 36 a sufficient distance to block the sun 16.

The attachable vehicle sun visor 10 of the present invention can also be utilized on the passenger side prior art sun visor 12, as shown in FIGS. 14 through 16, to block the sun 16 from the eyes and face of the passenger in the vehicle 14. As with the driver side use described above, the third section 38 can be slid downward to block the sun 16 when it is low on the horizon, as shown in FIG. 15 relative to FIG. 14. If the sun 16 is to the left of prior art sun visor 12, the passenger can extend the second section 36 outward to block the sun 16. If the sun 16 is both to the left and below, the passenger can extend the second section 36 outward and the third section 38 downward, as shown in FIG. 16, to block the sun 16 from his or her eyes. As with the driver side use of the present invention, the attachable vehicle sun visor 10 can also be utilized to block the sun 16 when it is positioned to the right of the passenger (i.e., out his or her side window). The passenger only needs to pivot the prior art sun visor 12 on the visor arm 32 to place it along the side window and then extend second section 36 outward and/or lower the third section 38 downward as desired or necessary to block the sun 16 from his or her eyes. Other uses of the attachable vehicle sun visor 10 on the passenger side of vehicle 14 will be readily apparent to those skilled in the art.

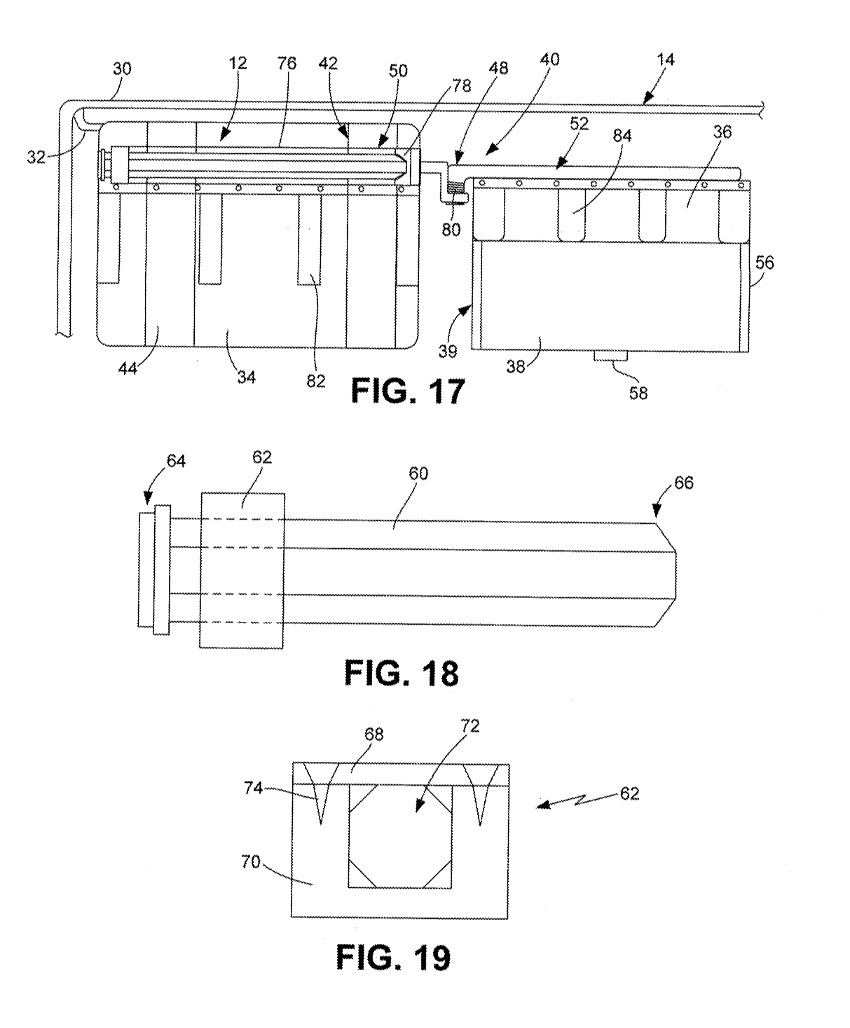

A preferred embodiment of the moving mechanism 40 is shown in FIGS. 17 through 19. The moving mechanism 40 of this embodiment comprises a slide bar 60 fixedly attached to the first section 34 and slider 62 that is slidably mounted on the slide bar 60 to slide between the first end 64 and the second end 66 of slide bar 60, as best shown in FIG. 18, to allow the second 36 and third 38 sections to slide inward and outward relative to first section 34. As shown in FIG. 19, the slider 62 has an upper section 68 and a lower section 70 that define an interior space 72 which is sized and configured to slidably receive the slide bar 60 therein. One or more attachment devices, such as the two screws 74 shown in FIG. 19, are used to fixedly join the upper 68 and lower 70 sections. Depending on the materials used for slider 62, a wide variety of materials and devices, such as bolts, adhesives, welding or the like, can be utilized for the attachment device 74. An outer member 76, shown in FIG. 17, interconnects the slider 62 with the combined second section 36 and third section 38 such that these components move together in relation to the first section 34. A stop member 78 prevents the slider 62 from sliding off the second end 66 of slide bar 60. The shape of the interior space 72 is in corresponding relation to the outer shape of slide bar 60. In a preferred embodiment, shown in FIGS. 18 and 19, the slide bar 60 has an octagon shape that allows the user to rotate the slide bar 60 inside the interior space 72 in a manner that locks the rotated slider 62 in relation to slide bar 60. Other shapes can be utilized. The embodiment of FIG. 17 also shows the user of a spring 80 associated with hinge 48 and the use of reinforcing or stiffening plates 82/84 on the first section 34 and second section 36, respectively. If desired, such plates can also be utilized on the third section 38.

In use, the driver and/or passenger will utilize the attachment mechanism 42 to securely attach the attachable vehicle sun visor 10 to an existing prior art sun visor 12. In the preferred embodiment, the straps 44 are placed around the prior art sun visor 12 and connected with the connecting mechanism 46, such as Velcro® or the like, to secure the first section 34 of the attachable vehicle sun visor 10 to the prior art sun visor 12. With the first section 34 secured in place, the driver/passenger slides down the third section 38 relative to the second section 36 to block the sun 16 when it is low on the horizon, as exemplified by FIG. 6. If the sun 16 is to the front right or left of the driver or passenger, then he or she slides the second section 36 outward from the first section 34, as exemplified in FIG. 8. If the sun 16 is both low on the horizon and to the right or left of the driver or passenger, then he or she will both slide down the third section 38 and slide out the second section 36, as exemplified in FIG. 10, to block the sun 16. If the sun 16 is out the driver or passenger side window, the driver/passenger will pivot the prior art sun visor 12, with the attachable sun visor 10 attached, to the side window and slide down the third section 38 and/or slide out the second section 36 as necessary or desired to block the sun 16 from coming through the side window. The driver can also block the sun 16 from his or her view when it is located along the passenger side by extending the second section 36 outward and then pivoting it relative to the first section 34, as shown in FIG. 7. If the sun 16 is also low on the horizon, the driver can slide the third section 38 down to block the sun 16, as shown in FIG. 8.

While there are shown and described herein specific embodiments of the present invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A vehicle sun visor for attachment to a prior art sun visor, said vehicle sun visor comprising:
a first section having an attachment means associated therewith for attaching said first section to said prior art sun visor;
a second section;
moving means interconnecting said first section and said second section for pivotally and slidably moving said second section outward relative to said first section; and
a third section having a slide means associated therewith for sliding said third section downward relative to said second section.

2. The vehicle sun visor according to claim 1, wherein said attachment means removably attaches said first section to said prior art sun visor.

3. The vehicle sun visor according to claim 2, wherein said attachment means comprises one or more straps configured to secure said first section to said prior art sun visor.

4. The vehicle sun visor according to claim 3, wherein said attachment means comprises a connecting mechanism associated with said straps to connect said straps together.

5. The vehicle sun visor according to claim 1, wherein said moving means comprises a hinge configured to pivot said second section relative to said first section, a first slide member configured to allow said second section to slide outward relative to said first section and a second slide member configured to allow said second section to slide outward relative to said hinge.

6. The vehicle sun visor according to claim 1, wherein said slide means comprises a pair of brace members on said second section, each of said brace members sized and configured to slidably engage an edge of said third section.

7. The vehicle sun visor according to claim 6, wherein said edge of said third section is serrated for step-wise movement of said third section.

8. The vehicle sun visor according to claim 1, wherein said third section comprises a pull member attached to or integral therewith.

9. A vehicle sun visor for attachment to a prior art sun visor, said vehicle sun visor comprising:
a first section configured to be secured to a surface of said prior art sun visor;
a second section pivotally and slidably attached to said first section to pivot and/or slide outward from said first section;
a third section slidably attached to said second section; and
attachment means associated with said first section for removably attaching said first section to said prior art sun visor.

10. The vehicle sun visor according to claim 9, wherein said attachment means comprises one or more straps configured to secure said first section to said prior art sun visor.

11. The vehicle sun visor according to claim 10, wherein said attachment means comprises a connecting mechanism associated with said straps to connect said straps together.

12. The vehicle sun visor according to claim 9 further comprising a moving means interconnecting said first section and said second section, said moving means having a hinge configured to pivot said second section relative to said first section, a first slide member configured to allow said second section to slide outward relative to said first section and a second slide member configured to allow said second section to slide outward relative to said hinge.

13. The vehicle sun visor according to claim 10 further comprising a slide means interconnecting said second section and said third section, said slide means having a pair of brace members on said second section that are sized and configured to slidably engage an edge of said third section.

14. The vehicle sun visor according to claim 13, wherein said edge of said third section is serrated for step-wise movement of said third section.

15. The vehicle sun visor according to claim 9, wherein said third section comprises a pull member attached to or integral therewith.

16. A vehicle sun visor for attachment to a prior art sun visor, said vehicle sun visor comprising:
a first section having an attachment means associated therewith for removably attaching said first section to said prior art sun visor, said attachment means having one or more straps configured to secure said first section to said prior art sun visor;
a second section;
moving means interconnecting said first section and said second section for pivotally and slidably moving said second section outward relative to said first section, said moving means having a hinge configured to pivot said second section relative to said first section, a first slide member configured to allow said second section to slide outward relative to said first section and a second slide member configured to allow said second section to slide outward relative to said hinge; and
a third section having a slide means associated therewith for sliding said third section downward relative to said second section, said slide means having a pair of brace members on said second section that are sized and configured to slidably engage an edge of said third section.

17. The vehicle sun visor according to claim 16, wherein said attachment means comprises a connecting mechanism associated with said straps to connect said straps together.

18. The vehicle sun visor according to claim 16, wherein said edge of said third section is serrated for step-wise movement of said third section.

19. The vehicle sun visor according to claim 16, wherein said third section comprises a pull member attached to or integral therewith.
